(19) United States
(12) Patent Application Publication
(10) Pub. No.: US 2017/0299936 A1
(43) Pub. Date: Oct. 19, 2017

(54) ELECTRO-OPTICAL CELL

(71) Applicant: Sergey Leonidovich Shokhor, Singapore (SG)

(72) Inventors: Sergey Leonidovich Shokhor, Saint Petersburg (RU); Denis Sergeevich Mosiyash, Saratov (RU); Aleksandr Pavlovich Loginov, Saratov (RU); Nikolai Pavlovich Abanshin, Saratov (RU)

(21) Appl. No.: 15/598,326

(22) Filed: May 18, 2017

Related U.S. Application Data
(63) Continuation of application No. PCT/RU2015/000503, filed on Aug. 12, 2015.

(30) Foreign Application Priority Data
Dec. 9, 2014 (RU) 2014149560

(51) Int. Cl. G02F 1/167

(52) U.S. Cl. CPC G02F 1/167; G02F 2001/1678; G02F 2202/36

(57) ABSTRACT

The present invention relates to optoelectronics and may be adapted to visualization, display, storage and information processing units and systems, such as 2D and 3D displays, including computer and television ones, light modulators, including, image processing and recognition devices, etc. The object of the present invention is an electro-optical cell which operates in both the transparent and reflective modes. The technical result is to provide a high rate of switching between states with different optical densities. This technical result is achieved by the following way: an electro-optical cell contains two dielectric plates at least one of which is transparent, which dielectric plates are coated on the internal surfaces with transparent conductive layers having terminals for connection to a power supply, wherein according to an embodiment of the invention, between said plates a nonpolar-fluid-based suspension is placed containing particles of elongated shape, opposite end portions of which carry different electric charges.

### CROSS-REFERENCE TO RELATED APPLICATIONS

The instant application is a Continuation Application of PCT International Application No. PCT/RU2015/000503, filed on Aug. 12, 2015, and claims priority to Russian Patent Application No. 2014149560, filed on Dec. 9, 2014, the entire specifications of both of which are expressly incorporated herein by reference.

### FIELD OF THE INVENTION

The present invention relates to optoelectronics and may be adapted to visualization, display, storage and information processing units and systems such as 2D and 3D displays, e.g. computer and television ones, light modulators, including, image processing and recognition devices, etc.

### BACKGROUND OF THE INVENTION

At present, various embodiments of the Suspended Particle Device (SPD) technology are known. The SPD technology is based on the principle of cylindrical particle orientation in a suspension in an applied electric field. In their OFF state, the particles are disordered and block light. In an electric field, particles acquire an induced dipole moment and align along the field. This technology is capable of achieving light transmittance of 75% to 80% and relatively high contrast. In such devices, a plurality of rod-like submicron particles within a nonconductive medium may rotate between substrates with superposed electrodes, one of which substrates is a transparent film, and the other is either transparent or reflective.

In particular, an electro-optical panel is known configured for controlling the transmission, absorption, and reflection of light, which comprises substrates with superimposed electrodes, one of which is a transparent film and the other is a reflective one. The fluid medium between the electrodes contains submicron asymmetrical dipole particles (see U.S. Pat. No. 3,841,732, IPC G02F1/172).

Another electro-optical device is known which includes a cell formed by the opposite cell walls of a light-modulating unit comprising a suspension with asymmetric carbon fibrils dispersed in a dispersion medium between said cell walls, and opposing electrodes associated with these cell walls for applying electric field to the suspension. Said carbon fibrils have an average length of less than 200 nanometers and a diameter of less than 3 nanometers, wherein the length is at least 3 times larger than the diameter (see CA2375735, IPC G02F1/17).

Despite the fact that the optical properties of cells and devices based on the SPD are quite satisfactory, this technology has a number of drawbacks which restrict its application.

1. Low switching time from a darker to a more transparent state. The induced electrical dipole moment is insufficient for a prompt response of particles to the applied voltage. The time of switching from a dark to a transparent state is from several to hundreds of milliseconds.

2. The transparency-to-nontransparency switching time takes seconds. This results from the fact that a cell darkens in this case only due to the Brownian motion of particles and is not controlled by the applied voltage.

Some electro-optical devices are known to be implied on the basis of electronic ink, E-ink. In electronic ink, a nonpolar-liquid suspension is used with two types of particles (typically black and white particles in a transparent suspension). The particles have been pretreated in such a way that when they are placed in a suspension based on a nonpolar fluid with charge control agents, the multicolored particles acquire opposite charges. When an electric field is applied, particles of different colors move in opposite directions. Accordingly, when a voltage of one polarity is applied, particles of the same color (say, white) are settled down on one (say, upper) of the plates, and the black particles, on the other (lower) one. When viewed from the upper plate side, the cell will be white. When the voltage polarity is reversed, the black particles are settled down on the upper plate, and the white ones—the lower plate. In this case, when looked from above the upper plate appears dark (see U.S. Pat. No. 6,113,810, IPC G02F1/167).

The main disadvantages of the devices based on E-ink are:

1. A relatively low level of light reflection (40-45% of the white paper level) does not allow for a full-color screen and limits their use as black-and-white electronic books. Even with a black-and-white screen this 45% reflection is insufficient for comfortable reading at average illumination.

2. Impossibility of video rendering because of the long switching times. With a typical distance of about 40 μm between the electrodes, the time of particle motion from one electrode to the other (image formation time) is in the order of 0.5 seconds.

3. The method is not applicable for devices operating in the transparent mode, but only for those working in the reflective mode.

The closest to the claimed solution is the Gyricon type display electro-optic cell (see U.S. Pat. No. 4,126,854, IPC G02B26/02). The cell contains two dielectric plates the inner surfaces of which are coated with transparent conductive layers, between the plates a nonpolar liquid suspension is placed containing microspheric particles with different electric charges on their opposite sides. Each of the two sides of such sphere is of a different color (e.g., white and black). The hemispheres are made of different materials. When the spheres are placed in a dielectric liquid, the hemispheres acquire different charges because of the different Z-potential. Therefore, each sphere possesses anisotropy not only of color, but also of charge. When a varying dc field is applied between the plates, the spheres rotate in accordance with their dipole moment and create a pixel of black or white color.

The drawbacks of this implementation are:

1. Complexity of providing a high-contrast image, since fabrication of two-color particles with precisely colored hemispheres is technically difficult not feasible.

2. When a sphere fails, an entire pixel is inoperative, because the spheres are big-sized (about 100 μm), and one sphere is used for one image pixel.

### SUMMARY OF THE INVENTION

The object of the present invention is an electro-optic cell which operates in both the transparent and reflective modes.

The technical result is to provide a high rate of switching between states with different optical densities.

This technical result is achieved by the following way: an electro-optical cell contains two dielectric plates at least one of which is transparent, which dielectric plates are coated on the internal surfaces with transparent conductive layers having terminals for connection to a power supply, wherein according to an embodiment of the invention, between said plates a nonpolar-fluid-based suspension is placed containing particles of oblong shape, opposite ends of which carry different electric charges.

### BRIEF DESCRIPTION OF THE DRAWINGS

The invention is explained in the accompanying drawings, wherein:

FIG. 1 shows an electro-optical cell in a nontransparent state with particles in a chaotic condition;

FIG. 2 shows an electro-optical cell in a transparent state;

FIG. 3 shows an electro-optical cell in a nontransparent state;

FIG. 4 shows a particle consisting of two different substances having different surface charges in the selected solvent-charger (dispersant-dispergent) system; or a cylindrical particle one part of which is functionalized in such a way that its different halves have different charges in the selected solvent-charger (dispersant-dispergent) system;

FIG. 5 shows a particle of a cylindrical shape partially coated with another substance having an opposite charge in a selected solvent-charger (dispersant-dispergent) system;

FIG. 6 shows a cylindrical particle opposite ends of which are covered with different substances so that the ends have different charge signs in the chosen solvent-charger system (dispersant-dispergent);

FIG. 7 is a schematic of a tilted deposition method;

FIG. 8 is a flow diagram of the polymer mask method for particle formation.

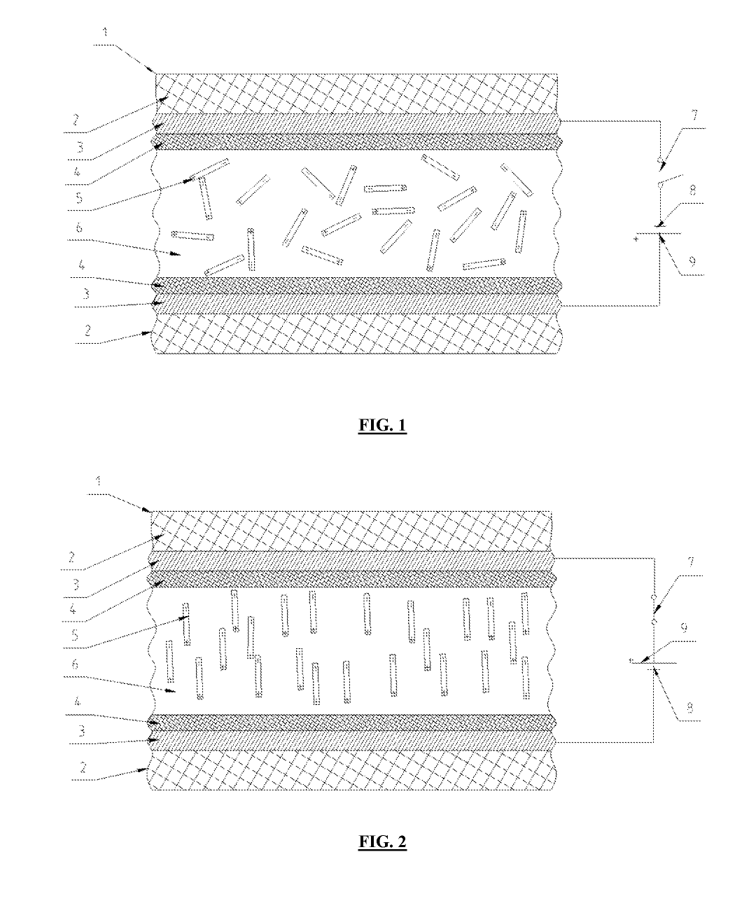

### DETAILED DESCRIPTION

The figures contain the following designations:
1—electro-optical cell;
2—dielectric plates, at least one of which is transparent;
3—conductive layers (electrodes);
4—insulating layers;
5—particle;
6—dispersion medium (nonpolar fluid);
7—switch;
8—power supply;
9—power supply positive electrode;
10, 11—substances having different surface charges in a selected solvent-charger (dispersant-dispergent) system;
12, 13—a substance and a polymer having different surface charges in a selected solvent-charger (dispersant-dispergent) system;
14, 15—substances with which particles have different charge signs in a selected solvent-charger (dispersant-dispergent) system;
16—substrate;
17—rod-like (cylindrical) particles grown on the substrate;
18—depositant;
19—masking polymer.

An electro-optical cell 1 contains two dielectric plates 2, at least one of which is transparent. The dielectric plates' 2 inner surfaces are coated by deposition with transparent conductive layers (electrodes) 3. Between the plates 2, a dispersion medium (suspension) 6 on the basis of a nonpolar fluid with particles 5 is placed. The particles 5 are oblong, their maximum linear size ranging from hundreds of nanometers to hundreds of microns, and their minimum linear size being in the range from several nanometers to hundreds of nanometers. The distance between the plates is equal to or larger than the maximum particle length. Each particle's longitudinal opposite ends are partially coated with different materials. When a particle is immersed in a dielectric liquid with chargers, different portions of the particle surface have different Z-potentials. Particle parts' charges can differ both in absolute value and sign. Thus, a dielectric fluid contains rod-like particles 5 having asymmetric charges. In the absence of an electric field, the particles 5 are in a disordered state, and the device has a certain optical density.

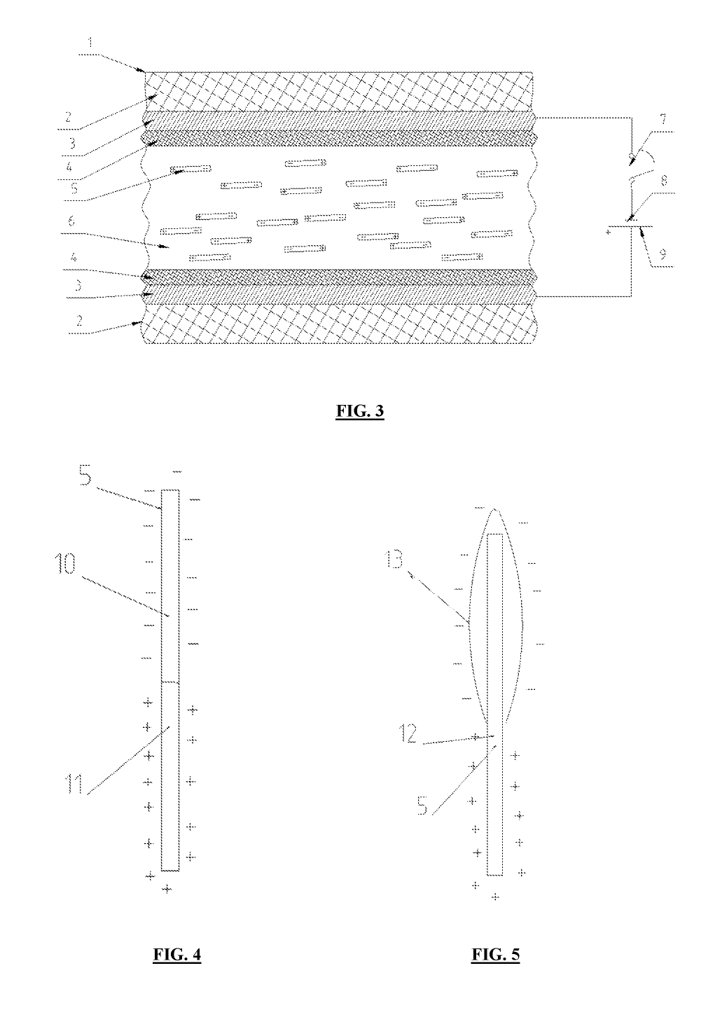

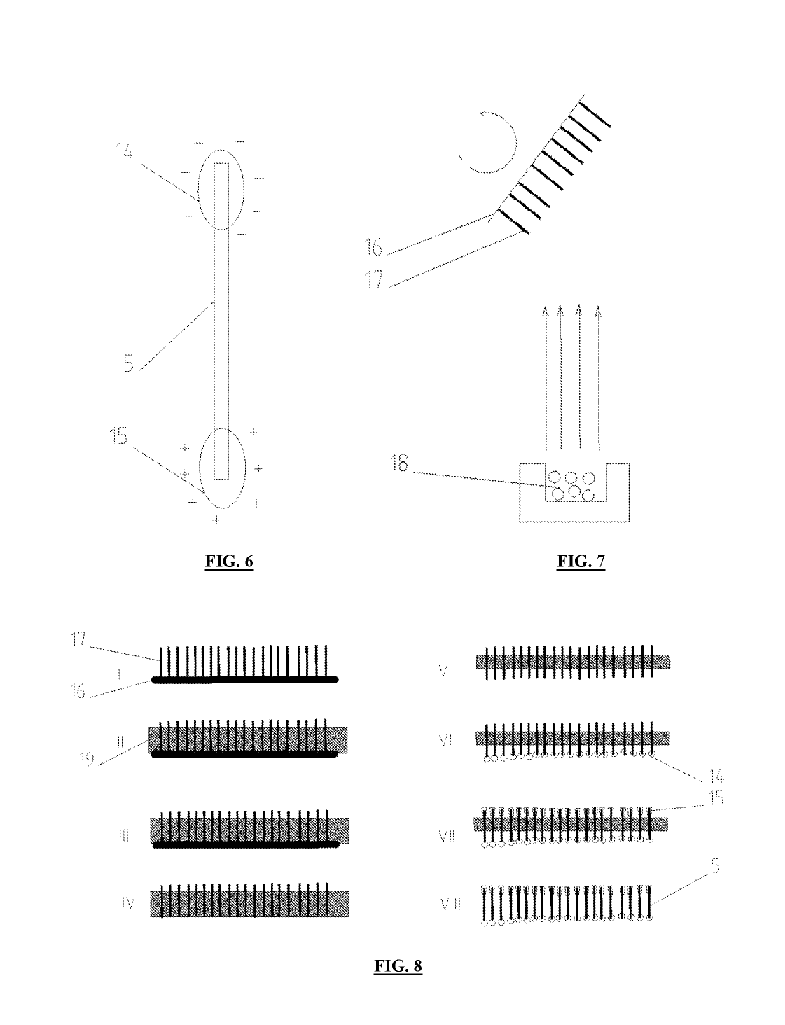

FIGS. 4-6 illustrate embodiments of particles with asymmetric properties. In FIG. 4, particle 5 is of a cylindrical shape and consists of two substances 10 and 11 which have different surface charges in the selected solvent-charger (dispersant-dispergent) system, or a cylindrical particle one part of which is functionalized in such a way that its different halves have different charges in the selected solvent-charger (dispersant-dispergent) system. In FIG. 5, a cylindrical particle 5 is partially coated with another substance such that in the selected solvent-charger (dispersant-dispergent) system the coated and uncoated particles have different charges. In FIG. 6, different ends of the particle 5 are covered with different substances such that the ends have different charge signs in the selected solvent-charger (dispersant-dispergent) system.

The particles described above can be fabricated in the following exemplary ways.

Tilted deposition (FIG. 7). This method is implemented by proceedings as follows: substrate 16 with cylindrical particles (17) grown on it is positioned at an angle to the source of a substance to be deposited. To provide uniform coating, the substrate is rotated. The atomization method should provide a directional beam of particles. For instance, vacuum thermal deposition may by applied, where an electron beam or direct thermal heating are used to heat the material. After deposition, particles are removed from the substrate, for example, by ultrasound treating or partial subetching. This method may provide particles of the type shown in FIG. 5.

Particles of the type shown in FIG. 6 may be provided, in particular, by the method below (FIG. 7).

On a substrate, cylindrical particles are grown. Then, the substrate is coated or overlaid with a polymeric film so that its thickness is a bit less than the particle average height. Said film layer may be formed in different ways.

1. A liquid polymer is centrifuged on a substrate surface, then the polymer is crosslinked by thermal or ultraviolet radiation, accordingly, forming the film.

2. A dissolved polymer is centrifuged or poured on a substrate, then the solvent is evaporated, accordingly, forming the film.

3. A solid polymeric film is placed over a plurality of particles and uniformly heated to a temperature above the polymer melting point but below the polymer decomposition temperature. The polymeric film melts and “permeates” the plurality of particles.

After the polymeric film is obtained, the substrate is removed. It may be, for example, subetched and peeled mechanically. Next, the particles' lower ends are exposed by an applicable method. For example, by subetching the polymer. After that, each side of the film-separated plurality of particles is treated in a corresponding manner. It may be chemical functionalization or covalent functionalization by polymers or other substances in a specific way to make the particles' different “ends” be oppositely charged in the selected solvent-charger (dispersant-dispergent) system.

Finally, the barrier polymeric film is removed, for example, in a selective solvent.

Operating principle of the device. When a constant electric field is applied, the particles 5 with asymmetric charge turn in accordance with the field polarity decreasing the optical density. If after that, a field of the opposite polarity is applied, the particles turn in accordance with the new field polarity. As the particles 5 are turning, optical density of the cell 1 increases. When the particles turn for 90 degrees (i.e. when they are oriented perpendicularly to the electric field), the cell has the maximum optical density.

If the field is switched off at this point, the device will remain in an opaque state. Further, due to the Brownian motion of the particles the cell will remain nontransparent.

If one of the cell dielectric plates 2 is colored, application of a constant electric field will make the device the color of this plate, if subsequently a reverse polarity field is applied, the particles turn making the device have the color of these particles. If the field is switched off at this moment, the device captures the color of the particles and due to the Brownian motion remains in this state.

As a dispersion medium, a liquid with a low dielectric permeability is utilized. For this purpose hydrocarbon nonpolar solvents are best suited. In particular, this can be hexane, dodecane, decane, other liquid saturated hydrocarbons and their isomodification (e.g. isoparaffins EXXON MOBIL CHEMICALS, commercial name Isopar).

As is known, existence and transfer of charges in a nonpolar liquid is possible only in the presence of surfactant micelles (see Ian Morrison. Dispersions in liquids: suspensions, emulsions, and foams. ACS National Meeting. Apr. 9-10, 2008 New Orleans. Ian Morrison. Ions and Charged Particles in Nonpolar Media. Cabot Corporation. Seiner Memorial Lecture. Carnegie Mellon University. May 15, 2003). Surfactants possess amphiphilic nature and at a particular concentration (minimal micelle-formation concentration) in a nonpolar solvent produce reverse micelles. Micelles often form around a free ion or a bound ion on a particle surface. Surfactant molecules environ ions and by their long hydrophobic “tails” prevent ion recombination. Ions themselves are formed due to dissociation of the molecules of the particles or extraneous impurities. In a nonpolar solvent such dissociation is many times weaker than in a polar solvent. Howbeit, the dissociation takes place owing to thermal energy fluctuations. Besides, micelles themselves are able to cause dissociation and interchange of charges. Further, the process of electrical stabilization of suspensions in nonpolar fluids under the action of surfactants goes with formation of “classical” double electrical layer of micelles charged with different sings. Particles acquire similar signs and undergo Coulomb repulsion which does not allow the particles to agglomerate. In this system, it is also possible to introduce a notion of Z-potential, which is determined by the double electric layer structure. The Z-potential is a function of a particle surface composition, a solvent used, and a surfactant type and concentration. Therefore, particles different in composition may gain opposite charges and, accordingly, Z-potentials of opposite signs. A charge sign depends on the presence and kind of dissociable groups within a particle molecule structure. A particle surface may be functionalized to impart it a certain charge. Functionalization may be covalent and noncovalent. A covalent functionalization implies such particle processing that results in forming specified functional groups on a particle surface (for example, treating nanotubes in a mixture of strong acids causes formation of carboxyl groups COOH on nanotube surfaces. In dissociation an atom of hydrogen H+ splits off, and the surface is charged negatively). Noncovalent functionalization means coating particles with another substance having a different Z-potential. For example, particles may be coated with a polymer. Depending on whether it is a cationic or anionic polymer, during dissociation of the polymer functional groups a particle acquires a different charge sign. Particles may be coated with low-molecular substances. In particular, oxidation of metal particles by oxygen forms metal oxide film on particle surface. Thus, if one particle is processed so that portions of its surface have unlike Z-potentials for the given solvent-surfactant system, then in a suspension such particles will have unlike charge signs on different surface parts, or will have charges of a same sign but of different values.

If such particles are now placed in a selected solvent with addition of a surfactant, then different parts of the particle surface will have unsimilar charges. A particle acquires a permanent dipole moment. As a surfactant, polyisobutylene succinimide (OLOA1200, Chevron) may be utilized as well as other OLOA dispergents. SPAN and TWEEN dispergents and emulsifiers may also be used (sorbitol and polyoxyethylated esters by Croda). Since particles have a permanent dipole moment, in such a system agglomeration of the particles is possible. Agglomeration may be caused by portions of particles with opposite signs attracting each other. To prevent agglomeration the method of suspension steric stabilization by polymers should be resorted to.

In the first case, to create a steric barrier a particle is first coated with an “anchor” polymer having good adhesion to the particle surface. Then, a polymer well soluble in a given solvent or having a portion readily soluble in this type of solvents is employed. By its one part the polymer is attached to the “anchor” polymer, while the long “tails” of the polymer are expanded free in the solvent. When particles approach, mechanical repulsion of the “tails” does not allow the particles to agglomerate. In the second case, to create a steric barrier block copolymers (A-B type) may be used. In this case, one part should have good adhesion to the particle surface, while the other part should be well soluble in a solvent.

To provide a steric barrier, hyperdispersants of Solspers type, Lubrizol, are applicable. Utilization of Cithrol DPHS emulsifying agents by Croda is also possible. This emulsifying agent is an A-B-A type block copolymer, where A is poly(12-hydrostearic acid), B-polyethylene oxide. At that, a particle surface should be hydrophilic or previously coated with a polymer having hydrophilic groups. In general, employment of other block polymers of A-B or A-B-A types is possible thus, that A parts are well soluble in saturated hydrocarbons, and Bparts have adhesion to a selected surface.

Thereby, a stable suspension of asymmetrically charged particles is obtained. Particle charging is implemented by selection of a suitable charger (surfactant). Suspension stabilizing is attained by selection of a suitable polymer for forming a steric barrier.

To create an electro-optical device a given suspension is placed between two electrodes, at least one of which is transparent. Two glasses with indium oxide (ITO) coating may be used. To eliminate current leakage, electrodes should be insulated, for example, by covering them with 0.2 μm silica layer. Another nonconductive transparent coating material is applicable to the electrodes.

To provide a desired optical density, concentration of particles in the suspension and distance between the electrodes may be varied.

In a suspension, particles are in a disordered state so that the light is absorbed and does not pass through the electro-optical device. When a constant field is applied, particles with asymmetric charge rotate according to the field polarity to make the device transparent. When after that, an opposite polarity field is applied, the particles commence rotating until a certain moment when they are perpendicular to the incident light, and the device becomes transparent. Once at this point the field is switched off, the device will remain in an opaque state owing to the Brownian motion which forces the particles to stay in a chaotic state.

Provided that one of the electrodes nontransparent, this electro-optical device may perform via ‘reflection’. In case of an applied constant field, particles turn according to the field polarity, and the device turns the color of the background. Once upon an opposite polarity field is imposed, the particles start to rotate and at a particular instant uprise perpendicular to the incident light so that device color becomes the color of the particles. Be the field at this point cut off, the device will retain the color of the particles.

A Gyricon rotating ball display taken as a prototype, has a typical spherical shape sized 100 μm. Switchover time of such display is within the range from 80 to 100 msec. However, according to the authors of the above article, as a sphere size decreases, switching speed increase. For a sphere of 30 μm in diameter 180 degree rotation time is about 10 msec.

In the case of an elongated (cylindrical or rod-like) particle of a comparable size expected switching times are not worse than 10 msec. Furthermore, in the present embodiment, to switch the device over from a highest transparency to a lowest transparency (or vice versa) requires rotation of the particles 90 degrees, not 180 degrees. In this situation, the switching time is approximately reduced by half, i.e. down to 5 ms, other factors being equal. Moreover, the smaller the particles, the shorter the switching time. Thus, for a particle size of several microns expected switching times are of the order of several milliseconds.

Besides, the present embodiment offers high contrast, reliability, and resolution of a display screen.

What is claimed is:

1. An electro-optical cell comprising:
two dielectric plates;
at least one of said plates is transparent;
wherein said dielectric plates are coated on the internal surfaces with transparent conductive layers having terminals for connection to a power source;
wherein a nonpolar-liquid-based suspension is placed between the plates;
wherein said nonpolar-liquid-based suspension has particles opposite portions of which carry different electric charges;
wherein the said particles have elongated shape.

2. The electro-optical cell according to claim 1, wherein particle's opposite ends are coated with different materials by a tilted deposition method.

3. The electro-optical cell according to claim 1, wherein the particles are produced by polymeric masking.

4. The electro-optical cell according to claim 1, wherein the particles are graphite nanoparticles.

5. The electro-optical cell according to claim 1, wherein the particles are carbon nanofibers.

6. The electro-optical cell according to claim 1, wherein the particles are carbon nanotubes.

7. The electro-optical cell according to claim 1, wherein each of the particles consists of two substances, characterized by different charges in suspension.

8. The electro-optical cell according to claim 1, wherein one end of the particle at least partially coated with a material, different from the particle's material.

9. The electro-optical cell according to claim 1, wherein the particle's opposite ends are partially coated with different materials.

10. The electro-optical cell according to claim 1, wherein the particles have maximum linear size ranging from hundreds of nanometers to hundreds of microns, and their minimum linear size being in the range from several nanometers to hundreds of nanometers.

11. The electro-optical cell according to claim 1, wherein the particles have cylindrical or rod-like shape.
